(19) United States
(12) Patent Application Publication
(10) Pub. No.: US 2018/0222473 A1
(43) Pub. Date: Aug. 9, 2018

(54) COLLISION AVOIDANCE FOR PERSONAL MOBILITY DEVICES

(71) Applicant: GM GLOBAL TECHNOLOGY OPERATIONS LLC, Detroit, MI (US)

(72) Inventor: Constandi J. Shami, Ann Arbor, MI (US)

(21) Appl. No.: 15/429,004

(22) Filed: Feb. 9, 2017

(51) Int. Cl. B60W 30/09; G08G 1/16; B62M 6/50; B60T 7/22; B60W 50/14; G05D 1/02; G06K 9/00; H04N 5/232

(52) U.S. Cl. CPC B60W 30/09; G08G 1/16; B62M 6/50; B60T 7/22; H04W 88/02; G05D 1/0251; G06K 9/00805; H04N 5/23293; B60W 50/14

(57) ABSTRACT

A system and method including a handheld mobile device for use with a personal mobility device, wherein the handheld mobile device comprises at least one camera, a processor, and a visual display, wherein the handheld mobile device is configured to: capture images of one or more nearby objects using the at least one camera; process the captured images by evaluating the captured images to determine at least one collision risk factor indicative of the magnitude of risk of a potential collision between the personal mobility device and the one or more nearby objects; display at least part of the captured images on the visual display; and transmit one or more notifications based on a value of the collision risk factor(s) to indicate the magnitude of risk of potential collisions between the personal mobility device and the one or more nearby objects.

### INTRODUCTION

The disclosure relates to determining potential collision risks of a personal mobility device and carrying out collision avoidance measures in response to the determined collision risks.

The capacity of electronic computing systems and devices are increasing with respect to their processing power and portability. For example, various handheld mobile devices have been developed, which include numerous electronic components, such as cameras and accelerometers. Additionally, a number of applications are being developed for such mobile devices and can provide users of the devices with a variety of features and functionality. One such application is a navigation or trip documenting application that provides directions to a user via a display on the mobile device or via audible cues. Many users use these navigation applications while driving vehicles or other personal mobility devices, such as electrically-assisted bicycles.

### SUMMARY

According to an embodiment, there is provided a personal mobility device collision avoidance system, comprising: a handheld mobile device for use with a personal mobility device, wherein the handheld mobile device comprises at least one camera, a processor, and a visual display, wherein the handheld mobile device is configured to: capture images of an area that includes one or more nearby objects using the at least one camera; process the captured images by evaluating the captured images to determine at least one collision risk factor indicative of the magnitude of risk of a potential collision between the personal mobility device and the one or more nearby objects; display at least part of the captured images on the visual display; and transmit one or more notifications based on a value of the collision risk factor(s) to indicate the magnitude of risk of potential collisions between the personal mobility device and the one or more nearby objects.

According to another embodiment, there is provided a method of carrying out one or more collision avoidance measures, comprising the steps of: capturing images of an area surrounding a personal mobility device using a camera of a handheld mobile device, wherein the handheld mobile device is mounted to a personal mobility device; processing the captured images to distinguish objects that are present in the captured images; determining one or more collision risk factors based on the processing of the captured images, wherein the collision risk factors indicate a magnitude of risk of a potential collision between the personal mobility device and one or more of the distinguished objects; and based on the magnitude of the collision risk factors, carrying out one or more collision avoidance measures.

According to yet another embodiment, there is provided a personal mobility device collision avoidance system, comprising: a handheld device, wherein the handheld device comprises at least one camera and a processing device, and wherein the handheld device is configured to: capture images of one or more nearby objects using the at least one camera; evaluate one or more collision factors based on processing the captured images using the processing device, wherein the processing of the captured images operates to determine whether a threat of collision between the personal mobility device and the one or more objects located in the area in front of the personal mobility device is present; and carry out one or more collision avoidance measures when it is determined that the personal mobility device is likely to encounter a collision with at least one of the one or more objects located in the area in front of the personal mobility device.

### BRIEF DESCRIPTION OF THE DRAWINGS

Exemplary embodiments will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram depicting an embodiment of a handheld mobile device and illustrates some hardware and components of the handheld mobile device;

FIG. 3 is a block diagram depicting a front view of the handheld device of FIG. 2 where the device is depicted as front-facing;

FIG. 4 is a block diagram depicting a rear view of the handheld device of FIG. 2 where the device is depicted as rear-facing;

FIG. 5 is a side view of a section of a personal mobility device with a mount thereon to hold a handheld mobile device and showing potential movement of the mount from a horizontal orientation to a vertical orientation;

FIG. 6 is a block diagram illustrating a potential scenario where the method and/or system provided herein may be utilized;

FIG. 7 is a perspective view illustrating a potential perspective of the point of view that an operator of a personal mobility device may have of the scenario of FIG. 6;

FIG. 8 is a block diagram illustrating an embodiment of presenting indicators on a visual display of a handheld mobile device; and

FIG. 9 is a flowchart illustrating a method of providing one or more collision avoidance measures.

### DETAILED DESCRIPTION

The system and methods below provide collision avoidance measures for a personal mobility device, such as a human-powered, electric, or electrically-assisted bicycle. The system, which may be referred to as a personal mobility device collision avoidance system, can include a handheld mobile device, such as a smartphone, that can be mounted to the personal mobility device. Upon activation of a collision avoidance application installed on the handheld mobile device, one or more collision avoidance measures may be provided. The collision avoidance application can capture images using one or more cameras of the handheld mobile device; determine at least one collision risk factor that is indicative of the magnitude of risk of a potential collision between the personal mobility device and one or more nearby objects; display at least part of the captured images on a visual display of the handheld mobile device; and transmit one or more notifications based on a value of the collision risk factor to indicate the magnitude of risk of potential collisions. In other embodiments, instead of, or in addition to, transmitting one or more notifications, one or more other collision avoidance measures may be carried out, such as, in the case where the personal mobility device is an electrically-assisted bicycle, cutting the electric assist of the bicycle and/or actuating a braking device of the bicycle.

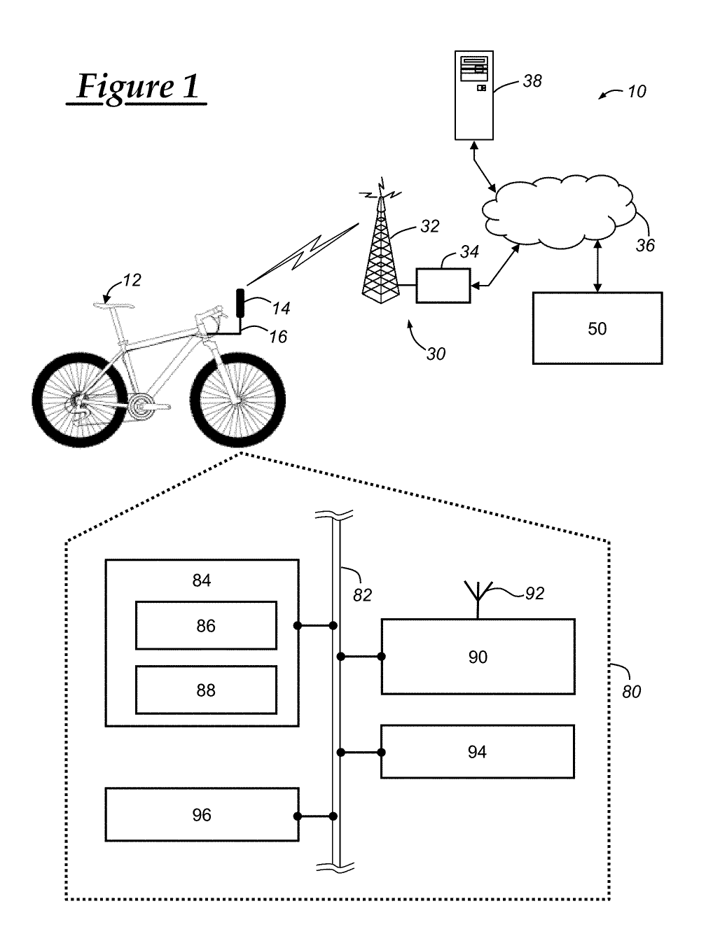

Referring now to FIG. 1, there is shown an operating environment that comprises a communications system 10 and that can be used to implement the method disclosed herein. Communications system 10 generally includes a personal mobility device 12, a handheld mobile device 14, one or more wireless carrier systems 30, a land communications network 36, a computer 38, and a remote facility 50. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Wireless carrier system 30 may be any suitable cellular telephone system. Carrier system 30 is shown as including a cellular tower 32 and a mobile switching center (MSC) 34; however, the carrier system 30 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 30 with the land network 36 or to connect the wireless carrier system with user equipment (UEs, e.g., handheld mobile device 14). Carrier system 30 can implement any suitable communications technology, including for example GSM/GPRS technology, CDMA or CDMA2000 technology, LTE technology, etc. In general, wireless carrier systems 30, their components, the arrangement of their components, the interaction between the components, etc. is generally known in the art.

Apart from using wireless carrier system 30, a different wireless carrier system in the form of satellite communication can be used to provide uni-directional or bi-directional communication with the vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the handheld mobile device 14 and the uplink transmitting station. If used, this satellite telephony can be utilized either in addition to or in lieu of wireless carrier system 30.

Land network 36 may be a conventional land-based telecommunications network that is connected to one or more landline telephones and connects wireless carrier system 30 to remote facility 50. For example, land network 36 may include a public switched telephone network (PSTN) such as that used to provide hardwired telephony, packet-switched data communications, and the Internet infrastructure. One or more segments of land network 36 could be implemented through the use of a standard wired network, a fiber or other optical network, a cable network, power lines, other wireless networks such as wireless local area networks (WLANs), or networks providing broadband wireless access (BWA), or any combination thereof.

Computers 38 (only one shown) can be some of a number of computers accessible via a private or public network such as the Internet. Each such computer 38 can be used for one or more purposes, such as a web server accessible by the handheld mobile device 14 via land network 36. Computers 38 can be used for numerous different purposes, such as for providing personal mobility device 12 and/or handheld mobile device 14 with backend services for use with firmware or software on device 12 or for use with mobile applications stored on device 14. Such computers 38 can also provide databases to store data received from the devices 12 and 14 and/or data that may be usable by such devices. A computer 38 can also be used for providing Internet connectivity such as DNS services or as a network address server that uses DHCP or other suitable protocol to assign an IP address to the handheld mobile device 14.

Remote facility 50 can provide the personal mobility device 12 and/or the handheld mobile device 14 with a number of different system back-end functions. The remote facility 50 may include one or more switches, servers, databases, live advisors, as well as an automated voice response system (VRS), all of which are known in the art. Remote facility 50 may include any or all of these various components and, preferably, each of the various components are coupled to one another via a wired or wireless local area network. Remote facility 50 may receive and transmit data via a modem connected to land network 36. A database at the remote facility can store account information such as subscriber authentication information, vehicle identifiers, profile records, behavioral patterns, and other pertinent subscriber information. Data transmissions may also be conducted by wireless systems, such as IEEE 402.11x, GPRS, and the like.

Personal mobility device 12 is depicted in the illustrated embodiment as a bicycle, but it should be appreciated that any other personal mobility devices including tricycles, electric bicycles and tricycles (including electrically-assisted bicycles and tricycles), internal combustion engine bicycles and tricycles, dune buggies, go-karts scooters, powered scooters, unicycles, all-terrain vehicles (ATVs), utility task vehicles (UTVs), golf carts, personal watercrafts (PWCs), manual and powered wheelchairs, etc. In some embodiments, the personal mobility device may be a manually-powered device, meaning that the device relies on an operator to manually provide power to the device for propulsion. Manually-powered devices may include electrically-assisted bicycles that have electric assist mechanisms, as described more below. Additionally, a handheld mobile device 14, as will be described in more detail below, may be attached to the personal mobility device 12. The device 14 may be attached to the mobility device 12 via a mount 16. The mount may be any such apparatus that can be attached to the personal mobility device 12 and to the handheld mobile device 14 such that the two devices are held in place. In one embodiment, the mount holds the mobile device 14 such that it faces an operator of the personal mobility device 12 during operation.

In the illustrated embodiment, personal mobility device 12 is an electrically-assisted bicycle with personal mobility device electronics 80 that include a communications bus 82, controller 84, a communications device 90, an electric assist mechanism 94, and a braking device 96. The different components of electronics 80 can communicate with one another via bus 82, or can communicate with one or more other electronics that are not integrated into the electronics 80, such as handheld mobile device 14 via the communications device 90. These components and devices constitute some of the numerous other components that may be included as part of an electric bicycle or other personal mobility device and, as such, it should be appreciated that the various electronics shown comprise only one potential embodiment. Additionally, it should be understood that the personal mobility device collision avoidance system and the method herein may be used with personal mobility devices that do not contain any electronics.

The personal mobility device 12 includes a controller 84 that may act as a central control unit for the electronic systems of the device 12. The controller 84 includes a processor 86 and memory 88, which can both be used to control the functionality of other devices, such as electric assist 94 and braking device 96. The processor 86 can be any type of device capable of processing electronic instructions including microprocessors, microcontrollers, host processors, controllers, and application specific integrated circuits (ASICs). Processor 86 executes various types of digitally-stored instructions, such as software or firmware programs stored in memory 88, which enable the device 12 to provide a wide variety of services. Memory 88 may include volatile RAM or other temporary powered memory, as well as a non-transitory computer readable medium that stores some or all of the software needed to carry out the various external device functions discussed herein.

The personal mobility device 12 also includes a communications device 90 and an antenna 92, such that it can carry out wireless communications. The communications device 90 may include of an electrical port, such as a universal serial bus (USB) port. Or, the communications device 90 can include an antenna 92 and a wireless chipset such that it may carry out wireless communications, such as short range wireless communications (SRWC) and/or cellular communications via carrier system 30.

Also included as part of the personal mobility device electronics 80 are the electric assist mechanism (“electric assist”) 94 and the braking device 96. The electric assist may be any type of powered system or component that can assist the operator in providing propulsion. In other embodiments, the device 12 may include an internal combustion engine system in place or in addition to an electric assist mechanism. The electric assist 94 can be controlled by the controller and may be actuated by an operator via one or more interfacing means, such as a throttle device attached to a handle bar of the device 12. Braking device 96 may be any device that can retard or stop the personal mobility device 12, such as a powered bicycle brake that includes a caliper or drum and an electrical actuating mechanism. In other embodiments, the braking device 96 can be included within a brake control module or anti-lock braking system (ABS) module and, in some embodiments, can control one or more braking mechanisms, such as frictional brakes, regenerative brakes, or a combination thereof.

Additionally, the electric assist 94 and/or braking device 96 may be configurable/controllable by a device that is connected to the electronics 80 via communications device 90. In one embodiment, device 14 may be connected to communications device 90 via SRWC or a universal serial bus (USB) connection from a port in the device 14 to a port in the device 12. In such an embodiment, the device 14 may include a certain application installed and executed thereon that are configured to provide signals, such as electronic instruction signals, to the personal mobility device 12 that may actuate the braking device or the electric assist mechanism, as will be explained more below.

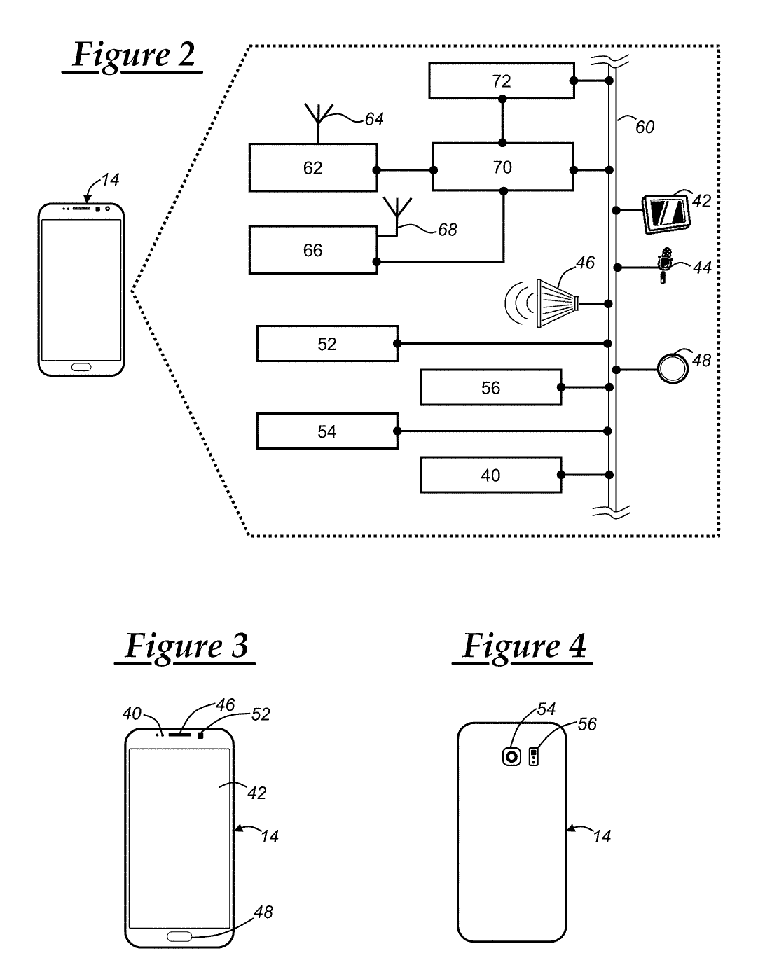

With reference to FIGS. 2-4, there is shown a schematic view of the hardware and components of a handheld mobile device 14 (FIG. 2), along with a front view (FIG. 3) and a back view (FIG. 4) of a handheld mobile device 14. Device 14 is shown as a smartphone having cellular telephone capabilities; however, in other embodiments, device 14 may be a tablet or any other suitable device. The mobile device includes: hardware, software, and/or firmware enabling cellular telecommunications and/or short range wireless communication (SRWC), as well as other wireless device functions and applications. The hardware of mobile device 14 comprises a processor 70, memory 72, wireless chipsets 62,66, antennas 64,68, cameras 52,54, and various device user interfaces. As mentioned above, the device 14 may be mounted on a personal mobility device 12.

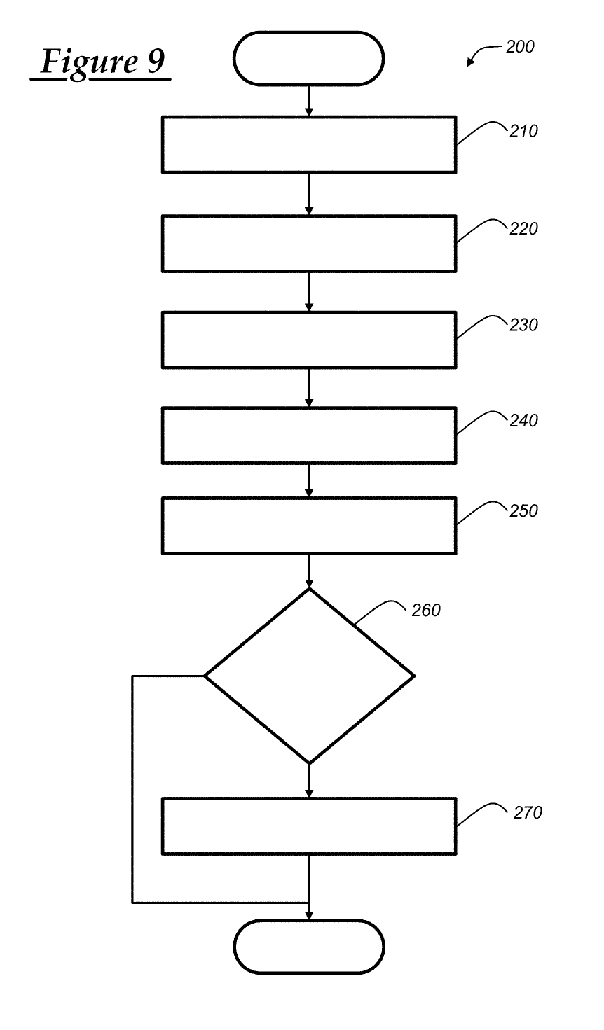

Processor 70 can be any type of device capable of processing electronic instructions and can execute such instructions that may be stored in memory 72, such as those devices and types of instructions discussed above with respect to processor 86. For instance, processor 70 can execute programs or process data to carry out at least a part of the method discussed herein. In one embodiment, device 14 includes an application that enables the method described below in FIG. 9. The processor may also execute an operating system for the handheld device, such as Android™, iOS™, Microsoft™ Windows™, and/or other operating systems. The operating system may provide a user interface and a kernel, thereby acting as a central control hub that manages the interfacing between the hardware and software of the device. Moreover, the operating system may execute mobile applications, software programs, and/or other software or firmware instructions.

Memory 72 may include RAM, other temporary powered memory, any non-transitory computer-readable medium (e.g., EEPROM), or any other electronic computer medium that stores some or all of the software needed to carry out the various external device functions discussed herein. In other embodiments, memory 72 may be a non-volatile memory card, such as a Secure Digital™ (SD) card, that is inserted into a card slot of device 14.

The processor 70 and/or memory 72 may be connected to a communications bus 60, which allows for the communication of data between the processor and other components of the device 14, such as cameras 52,54, camera flash 56, LED indicator 40, display 42, microphone 44, speaker 46, pushbutton 48, and various other components. The processor 70 may provide processing power for such components and/or may, through the operating system, coordinate functionality of the components, while the memory 72 may allow for storage of data that may be usable by such components. For example, the processor may run the primary operating system for the device 14, which may include displaying a graphical user interface (GUI) on a touchscreen display 42. In such an example, the GUI may include the display of images that may be stored in memory 72. The mobile device processor and software stored in the memory also enable various software applications, which may be preinstalled or installed by a user or by a manufacturer. This may include an application that can allow the device 14 to implement a collision avoidance system that can be used with personal mobility device 12. This application may use one or more of the components of the device 14, such as display 42, front-facing camera 52, rear-facing camera 54, and speaker 46, as will be discussed in more detail below.

The handheld mobile device 14 includes a short range wireless communications (SRWC) chipset 62 and antenna 64, which allows it to carry out SRWC, such as any of the IEEE 802.11 protocols, WiMAX™, ZigBee™, Wi-Fi direct™, Bluetooth™, or near field communication (NFC). The SRWC chipset may allow the device 14 to connect to another SRWC device. As used herein, a short range wireless communications device is a device capable of SRWC.

Additionally, handheld mobile device 14 contains a cellular chipset 66 thereby allowing the device to communicate via one or more cellular protocols, such as GSM/GPRS technology, CDMA or CDMA2000 technology, and LTE technology. Device 14 may communicate data over wireless carrier system 70 using the chipset 66 and antenna 68. Although the illustrated embodiment depicts a separate chipset and antenna for SRWC and cellular communications, in other embodiments, there may be a single antenna for both chipsets, a single chipset and multiple antennas, or both a single chipset and a single antenna. In such an embodiment, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Cameras 52 and 54 may be digitals cameras that are incorporated into device 14 and that enable device 14 to digitally capture images and videos. As shown in FIG. 3, camera 52 may be a front-facing camera, meaning that the camera faces an area in front of the front-side of the device 14, the front side being, in many embodiments, the side with the main visual display. Since an operator of a device 14 generally holds or positions such a device so that the visual display is in view, camera 52 in such an arrangement may face the operator, thereby allowing the operator to capture images and video of the operator and/or behind and surrounding the operator. As shown in FIG. 4, camera 54 is a rear-facing camera, meaning that the camera faces an area away from the front side of the device. Thus, in such an arrangement of usual use of the mobile device as described above, the camera may capture images or video of an area in front of the operator. In another embodiment, multiple cameras may be located on the handheld mobile device 14 such that the cameras capture images or video of the same area or at least part of the same area. In yet another embodiment, a stereo camera (or stereoscopic camera) or other camera with multiple lenses or separate image sensors may be used. In either of such embodiments, the camera(s) may be used to capture more information pertaining to the captured area, such as three-dimensional characteristics (e.g., distances of objects in the captured area), as will be known by those skilled in the art.

In some embodiments, the images or video captured by the camera may be displayed on visual display 42 even when the user is not presently capturing images or recording videos to be stored, thereby allowing the user to view the area that is being captured by the camera on the display. Accordingly, the device 14 may overlay or dispose certain graphical objects over the displayed camera feed. As will be explained in more detail below, collision warning objects or indicators may be displayed over the camera feed to provide the user with environmental information and/or may be based on the magnitude of risk of potential collisions (i.e. collision risk factors, as discussed more below). In addition, the cameras may each include a camera flash, such as camera flash 56 which is shown in FIG. 4 to be primarily for use with camera 54; however, such camera flash 56 or other camera flashes (not shown) may be used for other purposes such as for providing light in dark or low-light environments or providing a warning or other indicator to gain the attention of nearby persons.

Furthermore, the cameras may, during operation of the collision avoidance application, record and/or store images that have been captured in memory 72. In one embodiment, the camera may capture and store video whenever the application is running. The device 14 may then delete video that is older than a predetermined amount of time (e.g., 5 minutes) unless an operator specifically provides an indication that the video should be saved. This allows the camera to record video and for the operator to save recorded video of events that may transpire unexpectedly, such as a collision. If a user does not indicate that he/she would like to save the video and the video is older than a predetermined amount of time old, the camera may delete the video and free up memory. Additionally, if the device 14 detects a collision, via, for example, use of an accelerometer in the device 14 (not shown), then the device may automatically save the recorded video. In other embodiments, a user may desire to record video or images for the entire trip or time the application is running.

Handheld mobile device 14 also includes a number of device user interfaces that provide users of the mobile device with a means of providing and/or receiving information. As used herein, the term “device user interface” broadly includes any suitable form of electronic device, including both hardware and software components, which is located on the device and enables a device user to communicate with or through a component of the device. Such examples of device user interfaces include indicator 40, visual display 42, microphone 44, speaker 46, and pushbutton(s) 48. Indicator 40 may be one or more light indicators, such as light emitting diodes (LEDs), and, in some embodiments, may be located on a front-face of the device 14, as shown in FIG. 3. The indicator may be used for numerous purposes, such as to indicate to an operator of device 14 that there is a new notification on the device. Visual display or touch screen 42 is, in many embodiments, a graphics display, such as a touch screen located on the front face of the device 14, as shown in FIG. 3, and can be used to provide a multitude of input and output functions. Microphone 44 provides audio input to the device 14 to enable the user to provide voice commands and/or carry out hands-free calling via the wireless carrier system 70. Speaker 46 provides audio output to a vehicle occupant and can be a dedicated, stand-alone system or part of the primary device audio system. The pushbuttons 48 (only one shown) allow manual user input into the communication device 30 to provide other data, response, or control input. Other pushbuttons may be located on the device 14, such as a lock button on the side of the device 14, up and down volume controls, camera buttons, etc. Additionally, as those skilled in the art will appreciate, the pushbutton(s) do not need to be dedicated to a single functionality of the device 14, but may be used to provide interfacing means for a variety of different functionality. Various other vehicle user interfaces can also be utilized, as the interfaces of FIGS. 2-4 are only an example of one particular implementation.

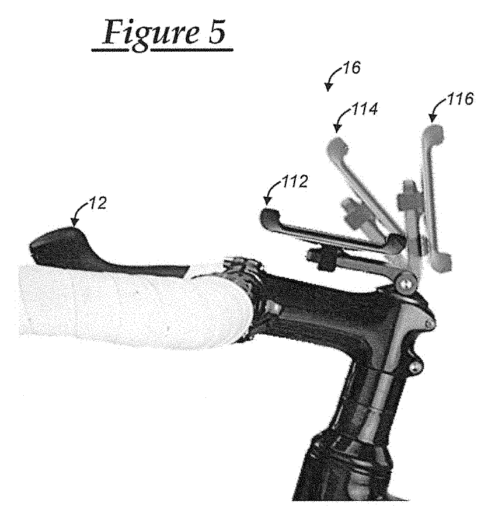

The application can be initiated by a user of the mobile device or may be automatically initiated. For example, a user may open the application on their device and click a “Start Trip” button. Alternatively, the application may automatically be initiated. In one embodiment, the phone may realize the presence of a near-field communications (NFC) chip on or near a mount that is attached to the personal mobility device. Upon such realization and depending on the data written to the NFC chip, the device may initiate the collision avoidance application. In addition, or alternatively, with reference to FIG. 5, the phone may use an accelerometer stored therein to determine an orientation of the device 14 relative to the earth. For example, when the phone is placed in mount 16 and the mount is set in an orientation 112, the collision avoidance application may be disabled. Upon the user placing the mount in orientation 116, the device may activate the collision avoidance application or resume carrying out certain functions of the application. Likewise, when a user then places the mount and, thus, the device back to orientation 112, then the device may pause, disable, or terminate the collision avoidance application.

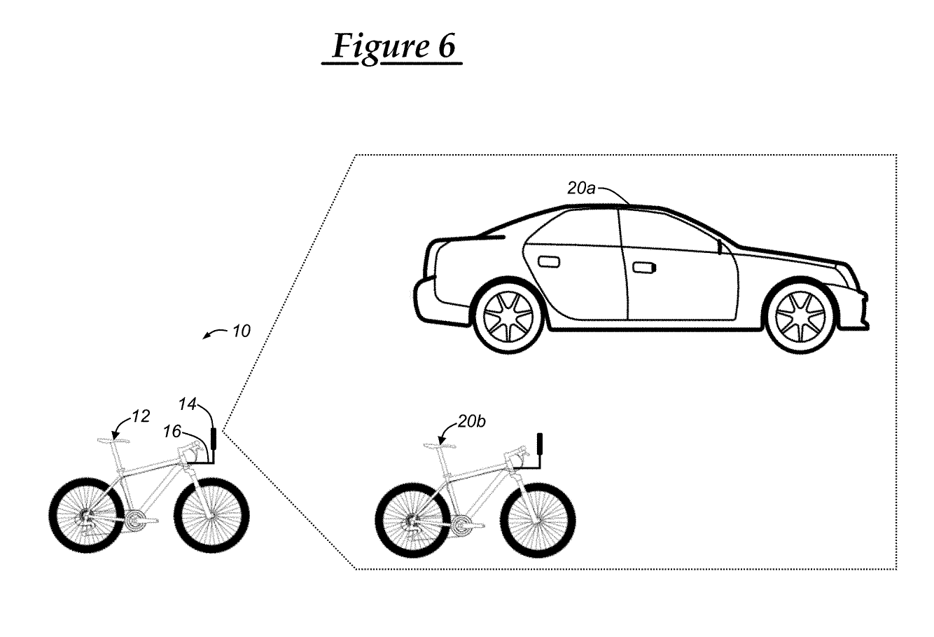

The application may also include image processing capabilities, which, in some embodiments, may enable information to be obtained regarding one or more objects nearby the device 14. For example, with reference to FIG. 6, there is shown a scenario of a personal mobility device trailing two objects, a vehicle 20a or personal mobility device 20b. It should be appreciated that, in other embodiments or scenarios, there may be any number of objects 20 and that objects 20 may be stationary or in motion. In this illustrated embodiment, rear-facing camera 54 may capture images of an area in front of the user as shown by the dashed lines. These captured images may be processed by an application using processor 70 and memory 72. Such processing may reveal information regarding the area in front of the camera, such as the identification of certain objects and/or properties regarding such objects. In another embodiment, a second rear-facing camera may be included in device 14, which may allow for images of the area in front of the user to be captured from different perspectives. Capturing images from multiple perspectives may reveal more information regarding one or more nearby objects, such as improved distance estimates and/or other information useful for collision avoidance.

Upon processing of the images, the handheld mobile device may send electronic instruction signals to the personal mobility device to avoid a potential collision and/or mitigate damage that may be caused by a potential collision. The electronic instruction signals may include instructions pertaining to the operation of the personal mobility device as to avoid a potential future collision or mitigate potential harm or damage caused by the potential future collision. For example, the device 14 may execute a collision avoidance application that, based on input received via a camera, can determine when a braking device or electric assist mechanism should be actuated such that the personal mobility device 12 can safely avoid such collision. Signals may be sent from device 14 as a result of such collision avoidance application to controller 84 of personal mobility device 12. Then, the controller may process the signals and, accordingly, provide signals to electric assist 94 and/or braking device 96.

In addition, the application may also allow the user to connect with the remote facility 50 or call center advisors at any time. Some applications may use a network connection to a remote facility 50, which allows the application to send and receive data. The device 14 may also include an application store or digital distribution service (e.g., Google™ Play, iTunes™) allowing for the downloading of certain applications, programs, plugins, or other software or firmware. For instance, a user may download a collision avoidance application that, when installed on the device 14, is used to configure the device 14 to carry out the method herein.

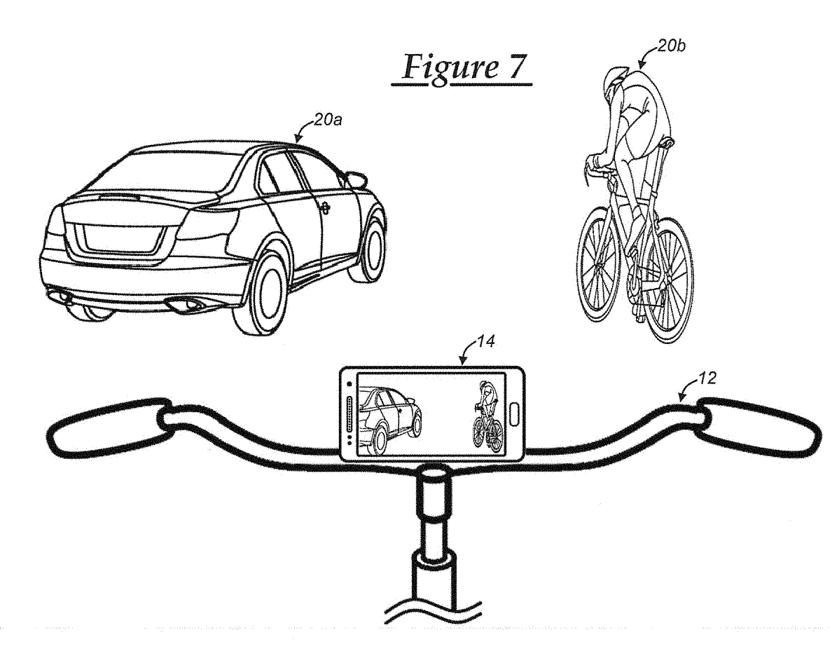

With reference to FIG. 7, there is shown a perspective view of the scenario of FIG. 6 where a personal mobility device 12 is trailing two objects, vehicle 20a and personal mobility device 20b. As shown, handheld mobile device 14 is mounted on device 12 with the front of the device 14 facing towards the area where an operator may be located when operating the personal mobility device 12. A rear-facing camera 54 (not shown in FIG. 7) may face the area in front of the mobility device 12 such that it may capture images of objects 20 in this area, as shown on the display 42 of mobile device 14.

With continuing reference to the scenario depicted in FIGS. 6-7, there will be described a method 200 of providing one or more collision avoidance measures, as shown in FIG. 9. The method 200 generally includes the steps of: capturing images of an area surrounding the personal mobility device using a handheld mobile device (step 210); process the images to determine one or more collision risk factors (steps 220 to 240); display captured images and indicators representing extent of collision risk factors (step 250); determine if a collision risk is greater than a threshold value (step 260); and, if so, carry out one or more collision avoidance measures (step 270). The method 200 may be carried out by a handheld mobile device 14, such as a smartphone, that is mounted on a personal mobility device 12.

The method may be initiated by a user of the device via operation of an application stored on device 14. Alternatively, the method may be initiated via realization that the device 14 has been mounted on a personal mobility device. In one example, a near-field communications (NFC) chip can be placed on or near a mount 16. Then, when a mobile device 14 is mounted via the mount 16, the device may realize the presence of the NFC chip thereby initiating an application that can carry out the method 200. Then, as explained above with reference to FIG. 5, the device 14 may use readings from an accelerometer to determine its orientation and, when the device's orientation is vertical (orientation 116), then the method may be carried out. In one embodiment, the method is carried out with the mobile device 14 mounted in front of the primary operator area such that the front face of device 14 (see FIG. 3) faces an operator of personal mobility device 12, as shown in FIG. 7. In other embodiments, the mobile device 14 may be mounted on the side, rear, or other location of personal mobility device 12, and device 14 may be mounted at varying angles.

The method 200 begins with step 210, wherein images are captured using a camera of a handheld mobile device, such as device 14. In one embodiment, the captured images are images of an area in front of personal mobility device 12 and can be captured by a rear-facing camera 54. In other embodiments, device 14 may include multiple rear-facing cameras and, thus, in such embodiments, both cameras may capture images. Multiple cameras capturing images of the same area may be useful for providing increased information to the device 14 thereby improving collision avoidance, at least in some embodiments. Additionally, or alternatively, front-facing cameras, such as camera 52, may be used to capture images or video of the operator and/or images of an area to the side and/or behind the operator. Accordingly, in such an embodiment, the following steps may be carried out in a similar manner, but taking into consideration the differing positional characteristics that exist among such an embodiment and the illustrated embodiment which is described with respect to capturing images or video in front of an operator.

In step 220, as images are captured, the images may be displayed on a display of the personal mobility device. In one embodiment, the rear-facing camera 54 sends the captured images to processor 70 via bus 60. The processor may process the images and/or store the images or other data pertaining to the images in memory 72. The processor may then send the images to display 42 via bus 60. As shown in FIG. 7, the images may be displayed on the display 42 for viewing by an operator or user of personal mobility device 12. In some embodiments, the images may be processed to improve image quality, to remove certain parts of the images, to crop the images, to overlay certain objects or graphics over the images, and/or to make various other image adjustment or modifications, many of which are known in the art.

In step 230, the processor may distinguish certain objects that are present in the captured images. For example, through use of image processing techniques, the processor may recognize certain objects, such as objects 20 as shown in FIG. 7. In one embodiment, mobile device 14 may use image processing software that may be part of a separate application or part of the collision avoidance application itself The image processing software may distinguish certain objects in the captured images and, through analysis of a series of images, may determine a velocity and/or acceleration of such distinguished objects. Additionally, the processing may calculate distances between the device 14 and the distinguished objects. Other information that may be useful in collision avoidance, collision warning, and/or mitigating the damage due to a collision may be calculated, estimated, and/or determined using the image processing software, such as sizes, proximities, and/or relative speeds of the objects. Techniques and image processing software for performing these functions is within the level of skill in the art and will be apparent to those skilled in the art.

In the example shown, the captured images include two objects 20a,b, such as a vehicle and a personal mobility device, as shown in FIG. 7. The captured images may include a set of images (or a video) and, via image processing software, a collision avoidance application may determine information relating to the objects. For example, information pertaining to physical properties of the objects may be determined, such as their size, position, velocity, acceleration, etc. In addition, information pertaining to the environment surrounding the user may be captured, such as information pertaining to lane markers or information pertaining to the direction the personal mobility device 12 is traveling. Such information may be immediately used by the processor to carry out certain collision avoidance techniques or warnings and/or may be stored in memory, such as memory 72 of device 14 or memory 88 of device 12.

In some embodiments, this information that is extracted from, or determined based on, the captured images using image processing software and other techniques may be displayed on display 42. For example, information relating to the user's present operation of the personal mobility device 12, such as the present velocity or trip distance, may be displayed for a user or operator to view. This information can be disposed over the camera/image feed on display 42 and may be configurable by a user via an application.

In step 240, a collision risk factor indicative of the magnitude of risk of potential collisions between the personal mobility device and the one or more nearby objects may be determined. In one embodiment, the information extracted or determined based on image processing of the captured images may be used to determine a probability, likelihood, or a risk factor that indicates the magnitude of risk of potential collisions between the device 14 and one or more object(s) 20. In addition to the information obtained from or based on the captured images, other information may be used to determine the collision risk factor. For example, velocity of the personal mobility device 12 may be monitored by a component of the device 12 or device 14 and, thus, such information may be sent to the collision avoidance application. Other information such as a stopping potential or distance of device 12 at the present velocity may be calculated or determined and sent to the collision avoidance application. Any other relevant information that may be probative to the calculation of risk of potential collisions may be obtained and used to determine the collision risk factor.

In other embodiments, there may be multiple collision risk factors, such as a collision risk factor associated with each distinguished object in the captured images. Then, such collision risk factors may be analyzed with regard to one another and an overall collision risk factor may be determined. For example, if one object 20a is slowly converging towards the left side of personal mobility device 12, it may have a relatively low collision risk factor due to the low speed which may enable the operator to direct their motion away from the object 20a. The same may be true if another object 20b is slowly converging towards the right side of the device 12. However, if both objects 20a and 20b are converging from opposite sides at the same time toward device 12, the risk of collision may increase dramatically. As such, analysis of collision risk with respect to individual objects can, at least in some embodiments, be evaluated with respect to other objects and the environment. Or, an overall collision risk factor may be calculated based on the evaluation of the individual collision risk factors.

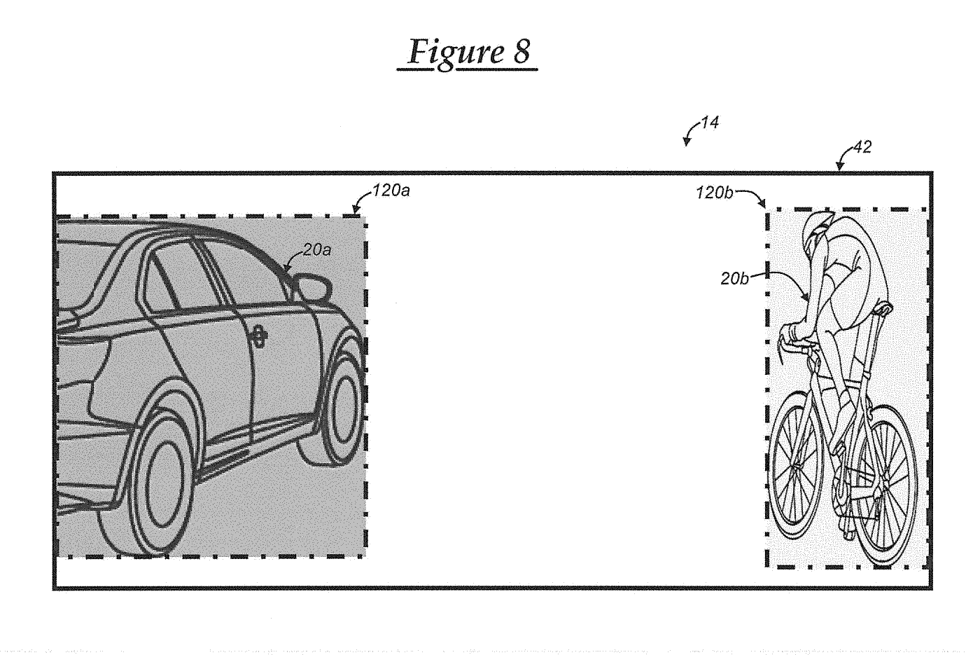

In step 250, one or more indicators may be displayed representing information pertaining to collision risks with one or more objects. In one embodiment, a collision risk factor may be determined for each distinguished object, as discussed above in step 240. The collision risk factors may be represented in the processor by numerical values and may be categorized based on their value. Then, based on the value or the category of the various collision risk factors, an indicator may be displayed on display 42. For example, as shown in FIG. 8, indicators such as highlighting 120a,b may be disposed around and/or over corresponding objects 20a,b. In other embodiments, other indicators may be presented, such as displaying various graphics on display 42, emitting light from LED indicators 40, sounding audio cues or notifications from speaker 46, emitting a flash from camera flash 56, etc.

In some embodiments, the indicators may be semi-transparent graphical objects covering the corresponding objects and the indicators' coloration may depend on the magnitude of the collision risk factor. In the case where the collision risk factor corresponding to an object 20a is relatively high, the indicator may be red. Or, the coloration or other features of indicators 120 may depend upon the relative magnitude between numerous collision risk factors. For example, if two collision risk factors are determined to be relatively high, instead of both corresponding objects having the same coloration, it may be desirable, in some embodiments, to provide differing coloration. The differing coloration may lead an operator to correct their positioning as to reduce the overall magnitude of collision risks or the magnitude of potential harm that may be caused by a collision whereas if both objects had the same coloration, the operator may not know which object poses less of a threat and, therefore, which way to steer device 12. It should be appreciated that this is only one such scenario and that different techniques may be used to warn the personal mobility device operator, to reduce collision risk, and/or to mitigate collision damage.

In step 260, it is determined whether one or more collision risk factors are greater than a threshold value. A threshold value may be any numerical or state value that may be preset, pre-configured, or predetermined by a manufacturer and/or operator. For example, in an embodiment where numerical values are used to represent collision risk factors, a threshold value may be a certain numerical value falling in the range of potential collision risk factor values. Then, upon determination of the collision risk factors, the threshold value may be compared to see if one or more collision risk factors exceed and/or are at the threshold value. In another embodiment where state values represent collision risk factors, the threshold value (or threshold state value) may be compared to the collision risk factor to determine if the collision risk factor meets the threshold requirements, which may be represented by the threshold state value and/or stored in memory. If it is determined that such threshold value is exceeded and/or met by one or more collision risk factors, then the method continues to step 270.

In step 270, one or more collision avoidance measures may be carried out. A collision avoidance measure is any action, operation, or instruction that may be executed or carried out in response to the determination of collision risk factors that operates to reduce or attempts to reduce the magnitude of risk of one or more potential collisions. It should be appreciated that the indicators discussed in step 250 are, in some embodiments, collision avoidance measures. The collision avoidance measures can provide notifications or indications to an operator of device 12 or other nearby persons or organisms. For example, the collision avoidance measures may comprise displaying various graphics on display 42, emitting light from LED indicators 40, sounding audio cues or notifications from speaker 46, emitting a flash from camera flash 56, etc. Or, the collision avoidance measures may take action to alter the operation of personal mobility device 12. For example, the collision avoidance measures may include sending signals to device 12 that instruct it to carry out various functions. In one scenario, the collision risk factor may be determined to be relatively high and the corresponding object of the risk factor may be directly in the path of device 12, as may be determined by image processing. If such collision risk factor is determined to be sufficiently high—e.g., such that it exceeds a threshold—then, a signal may be sent from mobile device 14 to personal mobility device 12 instructing the device to actuate or activate a braking device 96 and/or disable the electric assist 94. In other scenarios, it may be desirable to adjust a steering angle and/or launch the operator into the air.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive or. Put differently, the phrase “A, B, and/or C” includes: “A”; “B”; “C”; “A and B”; “A and C”; “B and C”; and “A, B, and C.”

What claimed is:

1. A personal mobility device collision avoidance system, comprising:
a handheld mobile device for use with a personal mobility device, wherein the handheld mobile device comprises at least one camera, a processor, and a visual display, wherein the handheld mobile device is configured to:
capture images of an area that includes one or more nearby objects using the at least one camera;
process the captured images by evaluating the captured images to determine at least one collision risk factor indicative of the magnitude of risk of a potential collision between the personal mobility device and the one or more nearby objects;
display at least part of the captured images on the visual display; and
transmit one or more notifications based on a value of the collision risk factor(s) to indicate the magnitude of risk of potential collisions between the personal mobility device and the one or more nearby objects.

2. The personal mobility device collision avoidance system of claim 1, wherein the handheld mobile device is a smartphone or tablet.

3. The personal mobility device collision avoidance system of claim 1, wherein at least one of the cameras of the handheld mobile device is a stereo camera.

4. The personal mobility device collision avoidance system of claim 1, wherein the handheld mobile device is configured to pause, disable, or continue certain operations based on an orientation or a change of orientation of the handheld device with respect to the earth.

5. The personal mobility device collision avoidance system of claim of claim 4, wherein the handheld mobile device is configured to pause or disable certain operations when the handheld mobile device detects a first orientation with respect to the earth, and wherein the handheld mobile device is configured to continue certain operations when the handheld mobile device detects a second orientation with respect to the earth, wherein the second orientation is approximately perpendicular with respect to the first orientation.

6. The personal mobility device collision avoidance system of claim 1, wherein the at least one camera includes a first camera and a second camera, wherein the first camera captures images of a first area, and wherein the second camera captures images of a second area, wherein the first camera is positioned on an opposing side of where the second camera is positioned.

7. The personal mobility device collision avoidance system of claim 1, wherein the at least one collision risk factor includes a collision risk factor for each of the one or more objects.

8. The personal mobility device collision avoidance system of claim 1, wherein at least one of the one or more objects are displayed on the visual display of the handheld mobile device, and wherein, for each of the displayed objects, a graphic is displayed over the displayed object, wherein the graphic indicates the magnitude of a collision risk factor that is associated with the displayed object.

9. The personal mobility device collision avoidance system of claim 8, wherein each of the graphics has is colored based on the magnitude of a collision risk factor that is associated with the displayed object.

10. A personal mobility device comprising the personal mobility device collision avoidance system of claim 1.

11. The personal mobility device of claim 10, wherein the personal mobility device is an electrically-assisted bicycle and wherein the handheld mobile device is mounted to the electrically-assisted bicycle.

12. The personal mobility device of claim 10, wherein the handheld mobile device is communicatively coupled to the personal mobility device and wherein the handheld mobile device is configured to transmit instructions to the personal mobility device to reduce a potential of collision between the personal mobility device and the one or more objects and/or mitigate harm due to a potential collision between the personal mobility device and the one or more objects.

13. The personal mobility device of claim 12, wherein the instructions direct the personal mobility device to disengage a propulsion or propulsion-aiding device of the personal mobility device and/or engage a braking device of the personal mobility device.

14. A method of carrying out one or more collision avoidance measures, comprising the steps of:
capturing images of an area surrounding a personal mobility device using a camera of a handheld mobile device, wherein the handheld mobile device is mounted to a personal mobility device;
processing the captured images to distinguish objects that are present in the captured images;
determining one or more collision risk factors based on the processing of the captured images, wherein the collision risk factors indicate a magnitude of risk of a potential collision between the personal mobility device and one or more of the distinguished objects; and
based on the magnitude of the collision risk factors, carrying out one or more collision avoidance measures.

15. The method of claim 14, wherein the determining step includes determining a collision risk factor for each of the distinguished objects.

16. The method of claim 15, wherein the collision avoidance measures includes displaying the captured images on a visual display of the handheld mobile device.

17. The method of claim 16, wherein the carrying out step includes, for each of the distinguished objects, displaying a graphic over the distinguished object, wherein the graphic indicates the magnitude of the collision risk factor of the distinguished object.

18. The method of claim 14, wherein the collision avoidance measures include sending an electronic instruction signal to the personal mobility device, wherein the electronic instruction signal includes instructions pertaining to the operation of the personal mobility device as to avoid a potential future collision or mitigate potential harm or damage caused by the potential future collision.

19. The method of claim 14, wherein the collision avoidance measures include presenting a notification or warning using one or more of the following: a light emitting device, an audio device, a tactile device, and a visual display.

20. A personal mobility device collision avoidance system, comprising:
a handheld device, wherein the handheld device comprises at least one camera and a processing device, and wherein the handheld device is configured to:
capture images of one or more nearby objects using the at least one camera;
evaluate one or more collision factors based on processing the captured images using the processing device, wherein the processing of the captured images operates to determine whether a threat of collision between the personal mobility device and the one or more objects located in the area in front of the personal mobility device is present; and
carry out one or more collision avoidance measures when it is determined that the personal mobility device is likely to encounter a collision with at least one of the one or more objects located in the area in front of the personal mobility device.
